(19) United States
(12) Patent Application Publication
(10) Pub. No.: US 2015/0046930 A1
(43) Pub. Date: Feb. 12, 2015

(54) Method And System For Integrating Applications

(71) Applicant: Lingua Next Technologies Pvt. Ltd., Pune (IN)

(72) Inventor: Rajeevlochan Phadke, Pune (IN)

(73) Assignee: Lingua Next Technologies Pvt. Ltd., Pune (IN)

(21) Appl. No.: 13/964,384

(22) Filed: Aug. 12, 2013

(51) Int. Cl. G06F 9/54

(52) U.S. Cl. CPC G06F 9/54
USPC 719/313

(57) ABSTRACT

A method and system for integrating computer applications is disclosed. A first data on a screen of a source application is intercepted. A target application is then executed and the first data is populated in one or more data fields on a screen of the target application. Thereafter, a second data on the screen of the target application is intercepted and populated in the one or more data fields on the screen of the source application.

### TECHNICAL FIELD

The presently disclosed embodiments are related to access data between computer applications. More particularly, the presently disclosed embodiments are related to a method and system for integrating computer applications.

### BACKGROUND

In an enterprise, a number of applications such as Human Resource Management, Payroll Management, Customer Relationship Management (CRM), and Accounts Management, provided by an Enterprise Resource Planning (ERP) platform, are used for efficient management of day-to-day business activities. Different companies offer ERP related solutions encompassing the above-mentioned applications. Various applications within a single ERP platform are integrated such that data between the services can be accessed with minimal human intervention. It is often the case that an enterprise makes use of one or more enterprise applications software from different companies. In such a case, integration of applications between different platforms is not possible. Thus, accessing data between applications from different platforms is a cumbersome process requiring human intervention to a significant extent.

The applications from different enterprise platforms can be integrated at the source code level. This however is a cost intensive proposition. Further, it is common practice for many companies to subscribe to different enterprise software in order to obtain the best products for different business applications. In such cases, the enterprise application is installed on the server of the companies providing the software. Hence, back-end integration is not possible for such computer applications.

Thus, there remains a need for improved techniques for integrating applications, which allows for data access between the applications with minimal human intervention.

### SUMMARY

According to embodiments illustrated herein, there is provided a method for accessing data between a first computer application and a second computer application. The method comprises intercepting a first data in the first application. The first data is intercepted on the basis of a first predefined criterion. The first data is then pushed to one or more data fields in the second application. Thereafter, a second data is intercepted in the second application. The second data is intercepted on the basis of a second predefined criterion. The second data is then pushed to one or more data fields in the first application.

According to embodiments illustrated herein, there is provided a system for accessing data between a first application and a second application. The system comprises a memory, which comprises one or more program instruction modules, and a processor operable to execute the one or more program instruction modules. The one or more program instruction modules comprise a first interception module, a first data push module, a second interception module and a second data push module. The first interception module is configured for intercepting a first data in the first application. The first data is intercepted on the basis of a first predefined criterion. The first data push module is configured for pushing the first data to one or more data fields in the second application. The second interception module is configured for intercepting a second data in the second application. The second data is intercepted on the basis of a second predefined criterion. The second data push module is configured for pushing the second data to one or more data fields in the first application.

According to embodiments illustrated herein, there is provided a computer program product for use with a computer. The computer program product comprises a non-transitory computer-readable data carrier storing a computer readable program for accessing data between a first application and a second application. The computer-readable program code comprises program instructions for intercepting a first data in the first application. The first data is intercepted on the basis of a first predefined criterion. The computer-readable program code comprises program instructions for pushing the first data to one or more data fields in the second application. The computer-readable program code also comprises program instructions for intercepting a second data in the second application. The second data is intercepted on the basis of a second predefined criterion. The computer-readable program code further comprises program instructions for pushing the second data to one or more data fields in the first application.

### BRIEF DESCRIPTION OF DRAWINGS

The accompanying drawings illustrate various embodiments of systems, methods, and embodiments of various other aspects of the invention. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram illustrating an application integration system, in accordance with at least one embodiment;

FIG. 2 is a flow diagram illustrating a method for integrating applications, in accordance with at least one embodiment.

FIG. 3 is another flow diagram illustrating a detailed method for integrating applications, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “at least one embodiment”, “an embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### DEFINITIONS

The following terms shall have, for the purposes of this application, the respective meanings set forth below.

A “computer” or a “computing device” refers to a device including a processor/microcontroller and/or any other electronic component, or a device or a system that performs one or more operations according to one or more programming instructions. Examples of the computing device include, but are not limited to, a desktop computer, a laptop, a personal digital assistant (PDA), a tablet computer and the like.

A “computer application” or an “application” or an “application software” refers to one or more applications used in business organizations and is an integral part of a (computer based) Information System. The examples of such application include, but are not limited to, customer relationship management, enterprise resource planning, IT service management, business intelligence, project management, collaboration, and human resource management. Various other applications such as a search engine application and a website are also included.

“Intercepting a data” refers to detecting data of interest on a screen of a computer application. The detection is based on a set of predefined rules which are included in the application integration system.

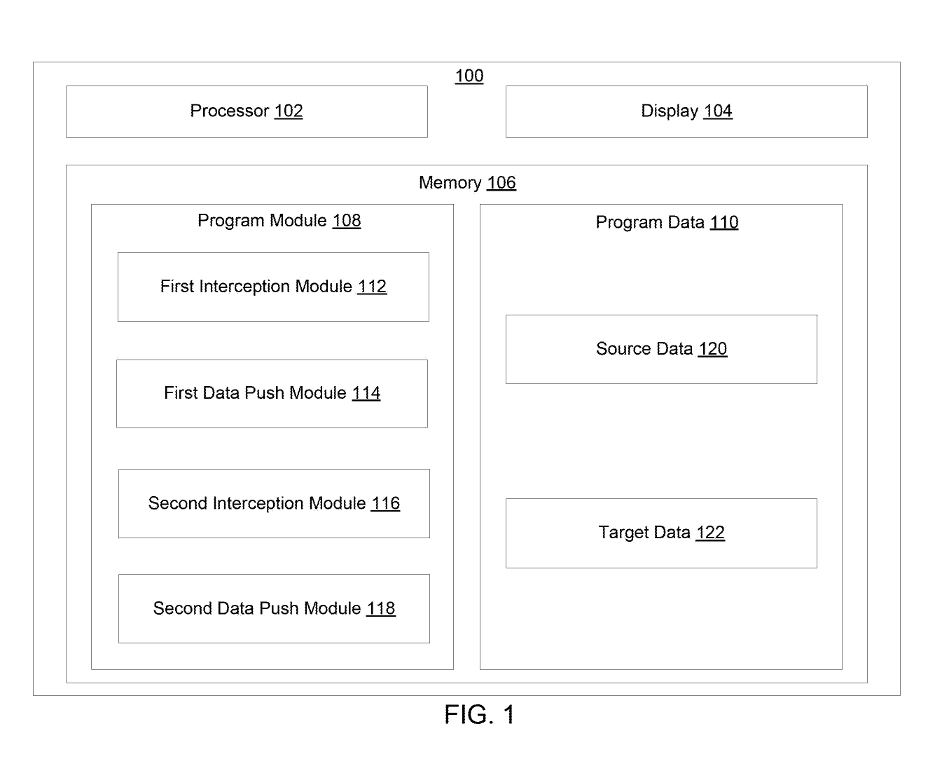

FIG. 1 is a block diagram 100 illustrating an application integration system 100 in accordance with at least one embodiment. The application integration system 100 includes a processor 102, a display 104, and a memory 106. The memory 106 includes a program module 108 and a program data 110. The program module 108 includes a first interception module 112, a first data push module 114, a second interception module 116 and a second data push module 118. The program data 110 includes a source data 120 and a target data 122. In an embodiment, in addition to the display 104 and the memory 106, the processor 102 may also be coupled to one or more input/output mediums (not shown) including, but not limited to, one or more keyboards, pointing devices, touchscreens, joysticks, microphones, cameras, scanners, and the like.

The processor 102 executes a set of instructions stored in the memory 106 to perform one or more operations. The processor 102 can be realized through a number of processor technologies known in the art. Examples of the processor 102 include, but are not limited to, an X86 processor, a RISC processor, an ASIC processor, a CISC processor, or any other processor. In an embodiment, the processor 102 includes a Graphics Processing Unit (GPU) that executes the set of instructions to perform one or more image processing operations.

The display 104 may include any known display device, for example, but not limited to, light emitting display (LED), organic light emitting display (OLED), Liquid Crystal Display (LCD), and other similar technologies. The display 104 may be externally connected to the application integration system 100, or in another embodiment, it may be embedded in the application integration system 100.

The memory 106 stores a set of instructions and data. Some of the commonly known memory implementations can be, but are not limited to, a Random Access Memory (RAM), Read Only Memory (ROM), Hard Disk Drive (HDD), and a secure digital (SD) card. The program module 108 includes a set of instructions (as program instructions modules) that are executable by the processor 102 to perform specific actions for integrating applications. It is understood by a person having ordinary skill in the art that the set of instructions in conjunction with various hardware of the application integration system 100 enable the application integration system 100 to perform various operations. During the execution of instructions, the source data 120 and the target data 122 may be accessed by the processor 102.

The first interception module 112 intercepts a first data on a first screen of a source application. The first interception module 112 intercepts the first data on the basis of a first predefined criterion. Examples of the first predefined criterion include, but are not limited to, a cursor movement on the screen of the first application, selecting a specific area on the screen of the source application, receiving an input on the screen of the source application from an input device, or location of the first data on the screen of the source application. Examples of the source application include, but are not limited to, an enterprise application, an office application, a web browsing application, a search engine application, or a website.

The first data push module 114 extracts the first data from the first screen of the source application and stores the first data in the source data 120. The first data push module 114 then executes a target application and populates the first data to one or more data fields in a first screen of the target application. The first data push module 114 then performs an action on the target application to generate a second data on a second screen of the target application. Examples of the action on the first screen of the target application include, but are not limited to, clicking on an icon on the target application or pressing the ‘Enter’ button on a keyboard. Examples of the target application include, but are not limited to, an enterprise application, an office application, a web browsing application, a search engine application, or a website.

In an embodiment, the first data push module 114 can be configured for pushing the first data to the one or more data fields on the first screen of one or more target applications. The first data push module 114 then executes the one or more target applications and populates the first data to the one or more data fields on the first screen of the one or more target applications. The first data push module 114 then performs an action on the first screen of the one or more target applications to generate the second data on the second screen of the one or more target applications. Further, in an embodiment, the first data push module 114 displays the second screen of the target application and the first screen of the source application simultaneously on the display 104.

The second interception module 116 intercepts the second data on the second screen of the target application. In an embodiment, the second interception module 116 can be configured for detecting the second data from the second screen of the one or more target applications. In an embodiment, the second interception module 116 can intercept the second data on the basis of a location of the second data on the second screen of the target application.

The second data push module 118 extracts the second data from the target application. The second data push module 118 stores the second data in the target data 122. The second data push module 118 then populates the second data to one or more data fields on the second screen of the source application. In an embodiment, the second data push module 118 can be configured for extracting the second data from the one or more target applications. The second data push module then pushes the second data from the one or more target applications to the one or more data fields on the second screen of the source application.

In an embodiment, the first interception module 112 and the second interception module 116 can be configured into a single interception module. Further, in an embodiment, the first data push module 114 and the second data push module 118 can be configured into a single data push module.

The source data 120 stores the first data when it is extracted by the first data push module 114. The target data 122 stores the second data when it is extracted by the second data push module 118. Each of the source data 120 and the target data 122 can be implemented as a database. The database can be implemented using technologies including, but not limited to, Oracle®, IBM DB2®, Microsoft SQL Server®, Microsoft Access®, PostgreSQL®, MySQL® and SQLite®, and the like.

The application integration system 100 can be further described by the following example:

An enterprise application such as a Payroll application provided by vendor A, herein referred to as a first application, is executed on a computing device and a user wants to extract an employee's details herein referred to as a second data from a Human Resource Application provided by vendor B, herein referred to as a second application, on the basis of the Employee's ID. When the first application is executed, multiple data fields appear on a first screen of the first application. A user enters a data in a first data field corresponding to an “Employee ID”. The first interception module 112 is configured for intercepting the data entered in the first data field. In an embodiment, once a six-digit employee id is entered in the first data field, the first interception module 112 intercepts the six-digit employee id, herein referred to as a first data, on the first screen of the first application. In another embodiment when the user presses the TAB button on a keyboard, the first interception module 112 intercepts the six-digit employee id as a first data on the first screen of the first application.

The first data push module 114 extracts the first data and stores it in the source data 120. The first data push module 114 then executes the second application and populates the first data in a data field corresponding to employee ID on a first screen of the second application. The first data push module 114 then performs an action such as clicking on an icon or executing the ENTER command, to generate the second data in one or more data fields on a second screen of the second application. In an embodiment, the first data push module 114 displays the second screen of the second application within the first screen of the first application on the display 104.

The second interception module 116 intercepts the data in the one or more fields on the second screen of the second application on the basis of the location of the one or more data fields on the second screen of the second application. In an embodiment, screen identifiers are used to define the location of the second data on the second screen of the second application.

The second data push module 118 stores the second data in the target data 122 and populates the second data in one or more data fields on the second screen of the first application. In an embodiment, the second data is populated on the basis of location of the one or more data fields on the second screen of the first application. In an embodiment, the second data is generated in one or more data fields on the first screen of the second application. Further, in an embodiment, the second data is populated in one or more data fields on the first screen of the first application.

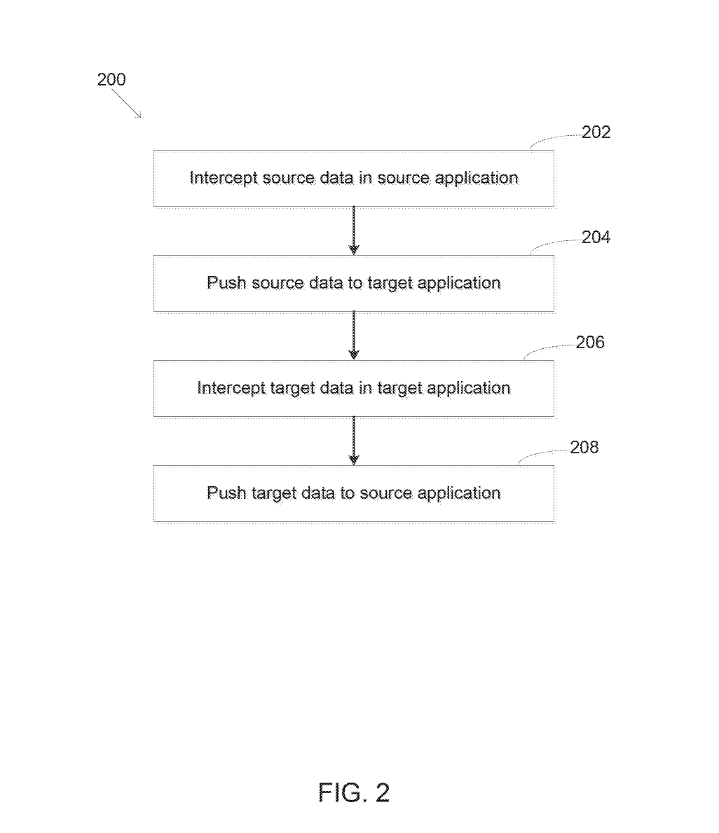

FIG. 2 is a flow diagram 200 illustrating a method for integrating applications, in accordance with at least one embodiment.

At step 202, the first data is intercepted. The first data is intercepted by the first interception module 112. Intercepting the first data refers to detecting a data of interest on the first screen of the source application.

At step 204, the first data is pushed to the one or more data fields on the first screen of the target application. The first data is pushed to the one or more data fields on the first screen of the target application by the first data push module 114.

At step 206, the second data is intercepted. The second data is intercepted by the second interception module 116. Intercepting the second data refers to detecting a data of interest on the second screen of the target application.

At step 208, the second data is pushed to the one or more data fields on the second screen of the source application. The second data is pushed to the one or more data fields on the second screen of the source application by the second data push module 118.

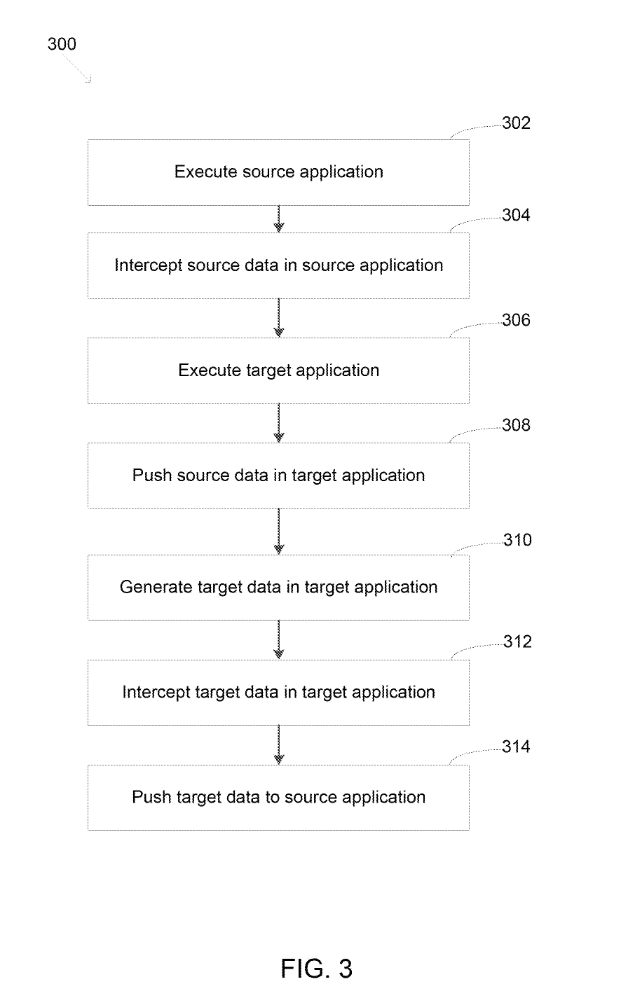

FIG. 3 is a flow diagram 300 illustrating a method for integrating applications, in accordance with at least one embodiment.

At step 302, the source application is executed on a computing device. In an embodiment, the source application refers to a number of computer applications, including, but not limited to, an enterprise application, an office application, a web browsing application, a search engine application, or a website.

At step 304, the first data is intercepted on the first screen of the source application by the first data interception module 112. The first data is intercepted on the basis of the first predefined criterion. In an embodiment, the first predefined criterion corresponds to a location of the first data on the first screen of the source application such that when the source application is executed, data at the specified location is intercepted as the first data. In another embodiment, the first data is intercepted when a user selects some data on the first screen of the source application.

At step 306, the target application is executed. The first data push module 114 executes the target application. In an embodiment, the target application is an enterprise application such as a CRM application or an HR application. The first data is extracted from the source application and stored in the source data 120 by the first data push module 114. The target application is then executed by the first data push module 114.

At step 308, the first data is populated on the one or more data fields on the first screen of the target application by the first data push module 114. The one or more data fields on the first screen of the target application are defined in the first data push module 114.

At step 310, the second data is generated in the second application by the first data push module 114. After entering the first data in the one or more data fields on the first screen of the target application, the first data push module 114 performs an action to populate the second data on the second screen of the target application. In an embodiment, the action refers to clicking on an icon on the first screen of the target application to generate the second data on the second screen of the target application.

For instance, in response to the data selected by the user on the first screen of the source application, the first data push module 114 may launch an e-learning application providing context sensitive help. The e-learning application may provide help associated with the data selected by the user on the second screen of the e-learning application. The actions associated with the first data push module 114 may happen in the background and may not be visible to the user.

At step 312, the second data on the second screen of the target application is intercepted by the second interception module 116. In an embodiment, the second data is intercepted based on the location of the second data on the second screen of the target application. When the second data is populated on the second screen of the target application, the second data interception module 116 intercepts the data at the specified locations as the second data.

At step 314, the second data is pushed to the one or more data fields on the second screen of the source application by the second data push module 118. The second data is extracted from the second screen of the target application by the second data push module 118. The second data is stored in the target data 122. The second data from the target data 122 is then populated in the one or more fields on the second screen of the source application by the second data push module 118.

For instance, the first interception module 114 may periodically intercept data from the first screen of the source application. In response to the intercepted data, the data push module 114 may trigger software as service (SAS) application and push the intercepted data on the first screen of the SAS application. The data generated on the second screen of the SAS application may be intercepted by the second interception module 116. The intercepted data is exported to the source application or stored locally at a predefined location by the second data push module 118. The actions performed by the various modules may be executed in the background and may not be visible to the user.

The disclosed methods and systems, as illustrated in the ongoing description or any of its components, may be embodied in the form of a computer system. Typical examples of a computer system include a general-purpose computer, a programmed microprocessor, a microcontroller, a peripheral integrated circuit element, and other devices, or arrangements of devices that are capable of implementing the steps that constitute the method of the disclosure.

The computer system comprises a computer, an input device, and a display unit. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard disk drive or a removable storage drive, such as a floppy disk drive, optical disk drive, etc. The storage device may also be a means for loading computer programs or other instructions into the computer system. The computer system also includes a communication unit. The communication unit allows the computer to connect to other databases and the Internet through an Input/output (I/O) interface, allowing the transfer as well as reception of data from other databases. The communication unit may include a modem, an Ethernet card, or other similar devices which enable the computer system to connect to databases and networks, such as LAN, MAN, WAN, and the Internet. The computer system facilitates inputs from a user through an input device, accessible to the system through an I/O interface.

The computer system executes a set of instructions that are stored in one or more storage elements in order to process input data. The storage elements may also hold data or other information, as desired. The storage element may be in the form of an information source or a physical memory element present in the processing machine.

The programmable or computer-readable instructions may include various commands that instruct the processing machine to perform specific tasks such as steps that constitute the method of the disclosure. The method and systems described can also be implemented using only software programming or hardware or by a varying combination of the two techniques. The disclosure is independent of the programming language and the operating system used in computers. The instructions for the disclosure can be written in all programming languages including, but not limited to, ‘C’, ‘C++’, ‘Visual C++’, and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, results of previous processing, or a request made by another processing machine. The disclosure can also be implemented in various operating systems and platforms including, but not limited to, ‘Unix’, DOS′, ‘Android’, ‘Symbian’, and ‘Linux’.

The programmable instructions can be stored and transmitted on a non-transitory computer-readable medium. The disclosure can also be embodied in a computer program product comprising a non-transitory computer-readable medium, or with any product capable of implementing the above methods and systems, or the numerous possible variations thereof.

The method, system, and computer program product, as described above, have numerous advantages. Some of these advantages may include, but are not limited to, integrating one or more services provided by an enterprise application from vendor A with one or more services provided by an enterprise application from vendor B.

Various embodiments of the Graphical User Interfaces (GUIs), methods, and systems for integrating computer applications have been disclosed. However, it should be apparent to those skilled in the art that many more modifications, besides those described, are possible without departing from the inventive concepts herein. The embodiments, therefore, are not to be restricted, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skill in the art will appreciate that the system, modules, and sub-modules have been illustrated and explained to serve as examples and should not be considered limiting in any manner. It will be further appreciated that the variants of the above-disclosed system elements, or modules and other features and functions, or alternatives thereof, may be combined to create many other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and are not limited to any particular computer hardware, software, middleware, firmware, microcode, etc.

The claims can encompass embodiments for hardware, software, or a combination thereof.

It will be appreciated that variants of the above disclosed, and other features and functions or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for accessing data between a first application and a second application, the method comprising:
intercepting a first data in the first application, wherein the first data is intercepted on the basis of a first predefined criterion;
pushing the first data to one or more data fields in the second application;
intercepting a second data in the second application, wherein the second data is intercepted on the basis of a second predefined criterion; and
pushing the second data to one or more data fields in the first application, wherein the above steps are performed by a processor.

2. The method of claim 1, further comprising displaying the second application and the first application simultaneously on a display unit.

3. The method of claim 2, wherein the second data is displayed on the second application.

4. The method of claim 1, wherein the first predefined criterion corresponds to at least one of a cursor movement on a screen of the first application, selecting a specific area on the screen of the first application, receiving an input in the first application from an input device and location of the first data on the screen of the first application.

5. The method of claim 1, wherein the second predefined criterion corresponds to a location of the second data on a screen of the second application.

6. The method of claim 1, wherein the first application is selected from an enterprise application, an office application, a web browsing application, a search engine application and a website.

7. The method of claim 1, wherein the second application is selected from an enterprise application, an office application, a web browsing application, a search engine application and a website.

8. The method of claim 1, wherein the first application is executed on a first platform and the second application is executed on a second platform.

9. The method of claim 1, wherein the first data is intercepted periodically, and wherein the second application is launched in response to the interception of the first data.

10. The method of claim 9, wherein the intercepted first data is pushed to the one or more data fields in the second application.

11. A system for accessing data between a first application and a second application, the system comprising:
a memory comprising one or more program instructions modules, wherein the one or more program instructions module comprise:
a first interception module configured for intercepting a first data in the first application, wherein the first data is intercepted on the basis of a first predefined criterion,
a first data push module configured for pushing the first data to one or more data fields in the second application,
a second interception module configured for intercepting a second data in the second application wherein the second data is intercepted on the basis of a second predefined criterion, and
a second data push module configured for pushing the second data to one or more data fields in the first application; and
a processor operable to execute the one or more program instructions modules.

12. The system of claim 11, wherein the first data push module is further configured for executing the second application.

13. The system of claim 11, wherein the first data push module is further configured for displaying the first application and the second application simultaneously on a display screen.

14. The system of claim 11, wherein the second information is displayed on the second application.

15. The system of claim 11, wherein the first predefined criterion corresponds to at least one of a cursor movement on a screen of the first application, selecting a specific area on the screen of the first application, receiving an input in the first application from an input device and location of the first data on the screen of the first application.

16. The system of claim 11, wherein the second predefined criterion corresponds to a location of the second data on a screen of the second application.

17. The system of claim 11, wherein the first data push module is further configured to identify the one or more data fields in the second application on the basis of a first set of screen identifiers.

18. The system of claim 11, wherein the second data push module is further configured to identify the one or more data fields in the first application on the basis of a second set of screen identifiers.

19. A computer program product for use with a computer, the computer program product comprising a non-transitory computer-readable medium storing a computer-readable program code for accessing data between a first application and a second application, the computer-readable program code comprising:
program instructions for intercepting a first data in the first application, wherein the first data is intercepted on the basis of a first predefined criterion;
program instructions for pushing the first data to one or more data fields in the second application;
program instructions for intercepting a second data in the second application wherein the second data is intercepted on the basis of a second predefined criterion; and
program instructions for pushing the second data to one or more data fields in the first application.

20. The computer program product of claim 19 further comprising displaying the second application and the first application simultaneously on a display unit.

21. The computer program product of claim 19, wherein the second data is displayed on the second application.

22. The computer program product of claim 19, wherein the first application is executed on a first platform and the second application is executed on a second platform.
